(19) United States
(12) Patent Application Publication
(10) Pub. No.: US 2014/0270265 A1
(43) Pub. Date: Sep. 18, 2014

(54) In-line Microphone Display and Method

(71) Applicant: Jason Dale Richison, Fort Scott, KS (US)

(72) Inventor: Jason Dale Richison, Fort Scott, KS (US)

(21) Appl. No.: 13/826,530

(22) Filed: Mar. 14, 2013

(51) Int. Cl. H04R 1/04

(52) U.S. Cl. CPC H04R 1/04
USPC 381/122

(57) ABSTRACT

An in-line microphone display device comprises a platform, a first electric connector connected to the platform, a second electric connector connected to the platform, an electric display connected to the platform and configured to display an image, and a microphone having a third electric connector configured to mate with one of the first and second electric connectors, wherein the electric display faces in a direction of the microphone so that the image is visible by a user of the microphone.

### BACKGROUND OF THE INVENTION

The present invention relates to an in-line microphone display and method.

A common problem for anyone using a microphone is tactfully keeping track of time. Many musicians do not wear a time piece, and it is sometimes considered rude for a person who is speaking to be obvious about checking to see what time it is. In addition, many venues do not have clocks readily available to the person speaking or entertaining.

Current methods for a speaker or entertainer to keep track of time when using a microphone would be to wear a watch of some type, depend on a nearby clock or timer, or have another person signal them at a certain time. Many times the microphone user does not have a watch or a clock available, and no one to cue them. These current methods of keeping time can be obvious and distracting to the user and the audience and it is sometimes considered inappropriate for the microphone user to be obvious about checking the time.

As can be seen, there is a need for solutions to these and other problems.

### SUMMARY OF THE INVENTION

In one aspect of the present invention, an in-line microphone display device comprises: a platform; a first electric connector connected to the platform; a second electric connector connected to the platform; an electric display connected to the platform and configured to display an image; and a microphone having a third electric connector configured to mate with one of the first and second electric connectors, wherein the electric display faces in a direction of the microphone so that the image is visible by a user of the microphone.

In one aspect, the electric display comprises a clock. In one aspect, the electric display comprises a liquid crystal display. In one aspect, the device further comprises a processor connected to and configured to control the liquid crystal display. In one aspect, the electric display is electrically connected to the first electric connector and is configured to draw electric current via the first electric connector. In one aspect, the device further comprises a power source connected to the electric display, wherein the electric display is not configured to draw electric current via the first or second electric connectors. In one aspect, the electric display is rotatable relative to the platform to a plurality of positions, wherein the electric display faces in the direction of the microphone in substantially all of the positions. In one aspect, the first electric connector has a male configuration that is configured to mate with a female electric connector, and wherein the second electric connector has a female configuration that is configured to mate with a male electric connector. In one aspect, the first electric connector comprises a male three-pin XLR connector and the second electric connector comprises a female three-pin XLR connector.

In one aspect, a method of obtaining information while using a microphone comprises: providing the in-line microphone display device as described; mating the first electric connector to a cooperative connector of a microphone wire; mating the second electric connector to a cooperative connector of a microphone; electrically powering the electric display by drawing current from the microphone wire via the first electric connector; and viewing the electric display.

These and other features, aspects and advantages of the present invention will become better understood with reference to the following drawings, description and claims.

### BRIEF DESCRIPTION OF THE DRAWINGS

FIG. 1 shows a front perspective view of one embodiment of the present invention.

FIG. 2 shows a back perspective view of one embodiment of the present invention.

FIG. 3 shows a perspective view of one embodiment of the present invention in use.

FIG. 4 shows front views of connectors 8, 10 according to one embodiment of the present invention.

FIG. 5 shows an electronic schematic of one embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

A device according to one embodiment of the present invention allows the user to keep track of time when using a microphone by providing a clearly visible time display in the normal line of sight of the user. This solves the problem of keeping track of time by allowing the user to have clear access to the time read-out while not being obvious to the audience. The in-line Microphone Time Display is different and better than current methods mentioned above because of its placement, subtlety, and convenience of use. It plugs into existing equipment and is located right where one needs it to be.

Referring now to the figures, the following reference numbers may refer to elements of the invention: ground terminal 1, which may be a chassis ground and/or cable shield; positive polarity terminal 2, which may be available for balanced audio circuits and may also be known as the “hot” terminal; negative polarity terminal 3, which may be available for balanced circuits and may also be known as the “cold” terminal; platform 4; electric display 6; first electric connector 8; second electric connector 10; release 12; cable connector or microphone wire connector 14; microphone connector 16; microphone 18; and in-line microphone display device 20.

In one aspect of the present invention, an in-line microphone display device 20 comprises: a frame, base, or platform 4; a first electric connector 8 connected to the platform 4; a second electric connector 10 connected to the platform 4; an electric display 6 connected to the platform 4 and configured to display an image; and a microphone 18 having a third electric connector, such as a microphone connector 16, configured to mate with one of the first and second electric connectors 8, 10, wherein the electric display 6 faces in a direction of the microphone 18 so that the image is visible by a user of the microphone 18.

The platform 4 may be cylindrical or any other shape, and may comprise a rigid material such as plastic or metal. The first and second electric connectors 8, 10 may comprise any known electric connectors, such as RCA connectors, plug connectors, XLR connectors, and so forth. They may comprise buttons, switches, hooks, or releases 12 that allow respective/cooperative connectors to be connected and disconnected, as understood by one of ordinary skill in the art. In the drawings, release 12 is shown on the back side of the display 6 next to first electric connector 8 where the microphone cable would plug in. In another embodiment it may be located on the front side of the display 6 next to second electric connector 10 where the device 20 plugs into the microphone. Often, a microphone cable will have its own release button which may lock into device 20, and in turn device 20 may lock into the microphone 18.

The connectors 8, 10, 14, 16 may comprise one pin (with grounding on the outside), two pins, three pins, or more pins, depending on the need for power, information signals, and so forth. The embodiment shown in FIGS. 4 and 5 show male and female XLR connectors having ground terminals 1, which may be chassis grounds and/or cable shields, positive polarity terminals 2, which may be available for balanced audio circuits and may also be known as the “hot” terminals, and negative polarity terminals 3, which may be available for balanced circuits and may also be known as the “cold” terminals.

The electric display 6 may comprise any known device that displays an image having information, such as a screen (e.g., touch screen), clock, LED display, LCD display, and so forth, which may or may not consist of mechanical and/or electronic components to relay information via an image. The microphone 18 may comprise any known microphone, including a powered, amplified, or non-powered microphone.

In one aspect, the device further comprises a processor, computer, or other electronic controller connected to and configured to control the liquid crystal display. It may be compatible with known data storage devices (e.g., SD™ cards) and information transfer devices and protocols (e.g., USB), allowing information to be transferred, processed, displayed, etc.

In one aspect, the electric display 6 is electrically connected to the first electric connector 8 and is configured to draw electric current via the first electric connector 8. In one aspect, the device further comprises a power source (e.g., battery, solar cell, capacitor, etc.) connected to the electric display 6, wherein the electric display 6 is not configured to draw electric current via the first or second electric connectors 8, 10, in which case the electric connectors 8, 10 may be used only to hold or support the electric display 6.

In one aspect, the electric display 6 is rotatable relative to the platform to a plurality of positions, wherein the electric display 6 faces in the direction of the microphone 18 in substantially all of the positions. This allows the display 6 to be turned from a horizontal position to a vertical position, etc., as desired by the user. In one aspect, the first electric connector 8 has a male configuration that is configured to mate with a female electric connector, and wherein the second electric connector 10 has a female configuration that is configured to mate with a male electric connector.

Other features, variations, and embodiments of the present invention will be described as follows, without intending to limit the scope of the present invention.

The electric display 6 may be digital, analog, or a display screen of any sort. It may also be battery powered, wind up, or powered by the voltage running through the audio cable going to the microphone. It may be illuminated or not.

The platform 4 may serve as a base to which the electric display 6 is attached. The platform 4 would also be attached to a 3 pin male XLR connector and a 3 pin female XLR connector with the original circuit going to and from the microphone 18 continuing through the two connectors. Voltage may or may not be accessed from this circuit.

A three-pin female XLR connector (which may be connector 10) is an industry standard type of connector used widely in the professional audio industry. This may attach the platform 4 to a microphone 18. The original circuit going to and from the microphone 18 may continue through this connector, and voltage may or may not be accessed from this circuit.

A three-pin male XLR connector (which may be connector 8) is an industry standard type of connector used widely in the professional audio industry. This may attach an incoming microphone cable to the platform 4 via cable connector 14. The original circuit going to and from the microphone may continue through this connector, and voltage may or may not be accessed from this circuit.

The electric display 6 and platform 4 may work together to place the display 6 in a desirable position for the user. The male and female 3 pin XLR connectors may be attached to the platform 4 and work together to continue the original circuit going to and from the microphone 18 via the microphone cable. Voltage may or may not be accessed from the original circuit going to and from the microphone 18 through the 3 pin XLR connectors. The XLR connectors may also allow for mechanically fastening the microphone 18 and microphone cable to the device 20. By combining the male and female 3 pin XLR connectors, the platform 4, and the electric display 6 together, a desired goal of having a convenient and mechanically stable time display in view of the user, while continuing the original circuit from which voltage may or may not be accessed, is achieved.

The electric display 6 could be mounted not just vertically, but horizontally, or at any angle depending on the direction the microphone 18 is being used.

A person could use a platform 4 for a time display that is nothing more than a thin ring that would fit over the end of a 3 pin female XLR connector and be thin enough to squeeze between a pair of male and a female 3 pin connectors plugged into each other. This would allow for a time display to be mechanically attached, but one would not be able to access voltage from the microphone circuit. Accessing voltage from the microphone circuit may allow power to be utilized to illuminate the time display. Also, the present invention allows for having a time display device that mechanically snaps in between an existing microphone cable and microphone 18.

The present invention could be used for different types of displays, such as a monitor with words, pictures, or any digital information. A person could plug this device in between a microphone and a microphone cable and then would have a time display readily available.

It should be understood, of course, that the foregoing relates to exemplary embodiments of the invention and that modifications may be made without departing from the spirit and scope of the invention.

What is claimed is:

1. An in-line microphone display device, comprising:
a platform;
a first electric connector connected to the platform;
a second electric connector connected to the platform;
an electric display connected to the platform and configured to display an image; and
a microphone having a third electric connector configured to mate with one of the first and second electric connectors,
wherein the electric display faces in a direction of the microphone so that the image is visible by a user of the microphone.

2. The in-line microphone display device as claimed in claim 1, wherein the electric display comprises a clock.

3. The in-line microphone display device as claimed in claim 1, wherein the electric display comprises a liquid crystal display.

4. The in-line microphone display device as claimed in claim 3, further comprising a processor connected to and configured to control the liquid crystal display.

5. The in-line microphone display device as claimed in claim 1, wherein the electric display is electrically connected to the first electric connector and is configured to draw electric current via the first electric connector.

6. The in-line microphone display device as claimed in claim 1, further comprising a power source connected to the electric display, wherein the electric display is not configured to draw electric current via the first or second electric connectors.

7. The in-line microphone display device as claimed in claim 1, wherein the electric display is rotatable relative to the platform to a plurality of positions, wherein the electric display faces in the direction of the microphone in substantially all of the positions.

8. The in-line microphone display device as claimed in claim 1, wherein the first electric connector has a male configuration that is configured to mate with a female electric connector, and wherein the second electric connector has a female configuration that is configured to mate with a male electric connector.

9. The in-line microphone display device as claimed in claim 8, wherein the first electric connector comprises a male three-pin XLR connector and the second electric connector comprises a female three-pin XLR connector.

10. A method of obtaining information while using a microphone, comprising:
providing the in-line microphone display device as claimed in claim 1;
mating the first electric connector to a cooperative connector of a microphone wire;
mating the second electric connector to a cooperative connector of a microphone;
electrically powering the electric display by drawing current from the microphone wire via the first electric connector; and
viewing the electric display.
